(19) United States
(12) Patent Application Publication
(10) Pub. No.: US 2026/0161783 A1
(43) Pub. Date: Jun. 11, 2026

(54) DETECTING MALICIOUS BINARY FILES

(71) Applicant: CYLANCE, INC., Plano, TX (US)

(72) Inventors: Aaron Mark Tresch FIENBERG, Irvine, CA (US); Steven John HENKEL, Waterloo (CA)

(21) Appl. No.: 18/973,306

(22) Filed: Dec. 9, 2024

(51) Int. Cl. G06F 21/56

(52) U.S. Cl. CPC G06F 21/56; G06F 2221/033

(57) ABSTRACT

Systems, methods, and software can be used to detect a malware file. In some aspects, a method includes: obtaining a file to be classified as either a malware file or a non-malware file; obtaining a sequence of elements of N₁-bytes or N₁-tokens from the file, with N₁ being an integer greater or equal to one; determining a sequence of hash values from the sequence of elements of N₁-bytes or N₁-tokens; obtaining a vector based on the sequence of hash values; providing a trained model with the obtained vector as input, the trained model outputting a data whose value enables a classification of the file as either a malware file or a non-malware file.

### TECHNICAL FIELD

The present disclosure relates to detecting malware that correspond to files whose execution may harm or compromise the functionalities, security, or data from devices.

### BACKGROUND

Detecting malware is a hectic subject of research. Indeed, the ability to detect a malicious software that is not yet referenced in databases, or that is in the early stages of mass deployment, is a key factor in the success of this strategy of defense of devices. Nowadays, solutions that rely on the use of machine learning techniques or deep learning techniques are widely adopted by the market due to their capacity of detecting malwares that classical solutions that only rely on signature-based detection techniques fail to detect. The proposed solution is in line with the use of machine learning techniques or deep learning techniques.

### DESCRIPTION OF DRAWINGS

FIG. 1 depicts a schematic diagram showing an example system that provides a malware detection technique according to an implementation.

FIG. 2 is a flowchart showing an example operation for determining if a binary file is malicious, according to an implementation.

FIG. 3 is a flowchart presenting an example method for generating a file embedding vector from a binary file, relying on the use of one or several hash functions.

FIG. 4 is a flowchart presenting an example method for training a machine learning model used to detect a malicious binary file.

FIG. 5 illustrates a high-level architecture block diagram of a computer according to an implementation.

Like reference numbers and designations in the various drawings indicate like elements.

### DETAILED DESCRIPTION

Usually, a binary file (often also referred to as a binary or executable) is defined as a file that comprises data directly readable by a device's hardware or a virtual machine (typically in binary code, i.e., sequences of 0s and 1s) rather than in plain human-readable text. Most of binary files have a structured format or headers that provide information on how to read the data. There is a wide variety of binary files. For example, executable files (.exe, .bin, .dll) that comprise compiled code that the computer can execute directly represent a class of binary files. Executable files can either run standalone (like a program) or install software (like a setup or installer file) by unpacking and placing some necessary components in specific directories on a device. In addition, binary files or executable files require specific software or utilities for interpretation and are commonly opened by applications designed to handle their specific format. Another example of a binary file is a PE (Portable Executable) file or an ELF (Executable and Linkable Format) file, that are file formats used to store executable code and other data for programs on respectively Windows and Linux systems. They contain information necessary for the operating system to load and execute the program. Therefore, a binary file is a broad term that encompass any file that can be directly executed by a computer. For example, bytecodes that are intermediate code between source code and machine code can also be viewed as binary files. Indeed, even if bytecodes are not directly executed by the device's hardware, they can be considered as binary files as bytecodes are usually executed by a runtime environment (such as a Java Virtual Machine for Java bytecodes, or a Python interpreter for Python bytecodes). In addition, it should be noted that scripts written in languages like PowerShell can be compiled into binary executables. Indeed, tools like PyInstaller or py2exe can turn Python scripts into executable binaries. Attackers sometimes convert PowerShell or Python scripts into binary files to bypass script-blocking security tools. Therefore, binary files in this context can be associated with a lot of different high-level languages. Malicious scripts can be “packed” within a binary file using packers or obfuscators. The binary file may contain an embedded script that is unpacked or decrypted at runtime. Attackers use the binary representation approach to make it harder for signature-based antivirus to detect the script contents directly. Therefore, the analysis of binary files is an important aspect to take into consideration for protecting electronic devices. In the previous discussions, the examples of binary files were mainly related to computers. However, other electronic devices can use binary files. For example, Android Application Package (apk) files adopted by Android for apps distribution and installation can be viewed as binary files. Indeed, an .apk file is a container that holds compiled code in DEX (Dalvik Executable) format, which is used by Android's runtime to execute the app, with other components such as resources (i.e. images, sounds, and layouts), and manifest files that describe the app's structure and permissions. Another kind of binary files are iOS App Store Package (ipa) files which comprise compiled app code (in binary format for iOS devices' ARM architecture), as well as resources (images, audio, user interface files) and info.plist files comprising metadata about the app such as version information, permissions, configuration parameters, etc. . . . The present disclosure can be applied to that kind of files. In a variant, it can also be applied to source code files; source code files can cover a large number of different file types; they can be either assembly files, or other files comprising human-readable instructions written in a programming or scripting language (such as C, Java, Python, JavaScript, etc.).

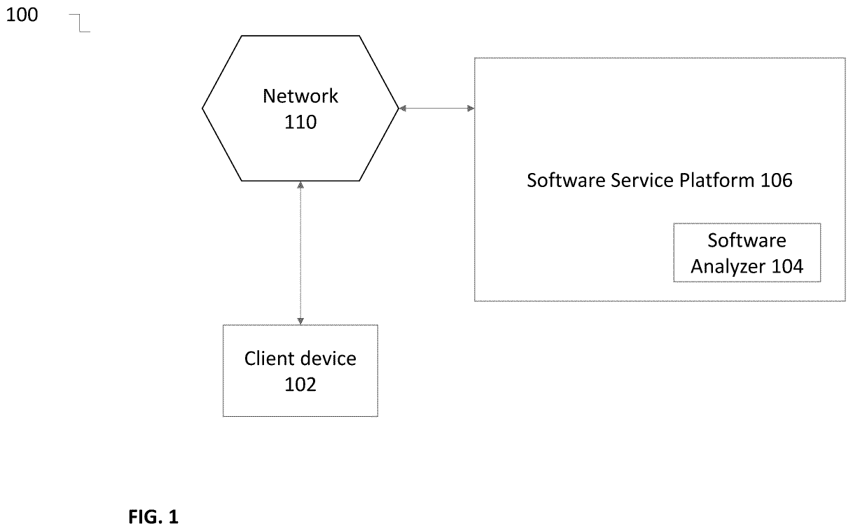

FIG. 1 depicts a schematic diagram showing an example system that provides a malware detection technique according to an implementation. More precisely, the system 100 includes a software service platform 106 that is communicatively coupled with a client device 102 over a network 110. The client device 102 represents an electronic device that provides a file (either a binary file or a source code file) to be analyzed. In some cases, the client device 102 can send a compressed or encrypted file to the software service platform 106 for a malware detection analysis. Hence, the software service platform 106 has to decompress or decrypt the file in this context. In some cases, the software service platform 106 can send the output of the malware detection analysis to the client device 102.

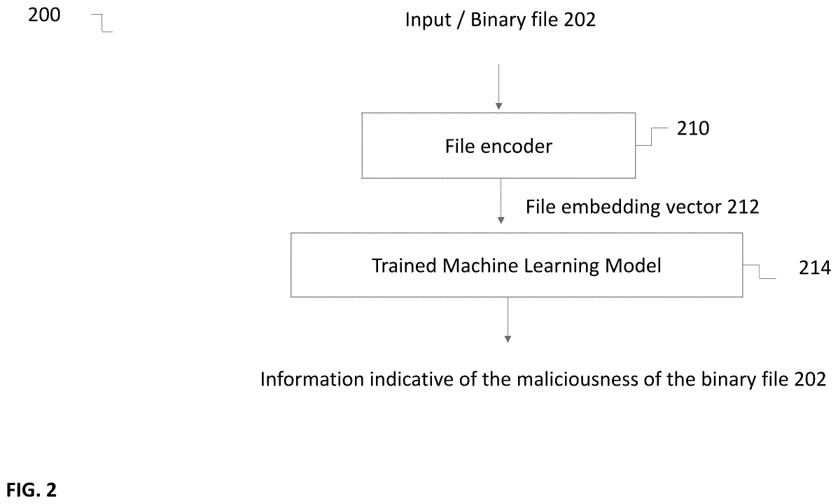

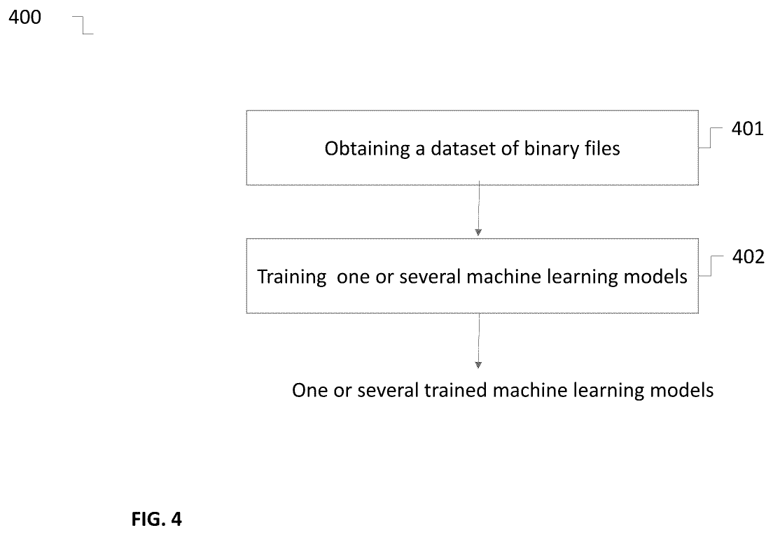

The software service platform 106 represents an application, a set of applications, software, software modules, hardware, or any combination thereof, that detects malware files. The software service platform 106 can be an application server, a service provider, or any other network entity. The software service platform 106 can be implemented using one or more computers, computer servers, or a cloud-computing platform. The software service platform 106 can be used to run trained machine learning models that are used in a malware detection process or malware analysis. In a variant, the software service platform 106 can also perform the training process discussed in FIG. 4 and associated descriptions. The software service platform 106 includes a software analyzer 104. The software analyzer 104 represents an application, a set of applications, software, software modules, hardware, or any combination thereof, that performs data preprocessing on a received binary file or a source code file. In some implementations, the software analyzer 104 can generate a file embedding vector of the binary file or the source code file, which is used as an input of a trained machine learning model. FIGS. 2-4 and associated descriptions provide additional details of these implementations. In a variant, both the software analyzer 104 and the software service platform 106 are executed in the client device 102 itself. Indeed, more and more client devices, thanks to technological developments, are capable of running trained machine learning models locally. For example, iPhones that can be viewed as client devices are suitable for running machine learning models locally as they provide a core machine learning framework, a dedicated chip component such as the Apple neural engine (ANE) optimized for performing machine learning tasks.

Turning to a general description, the client device 102 may include, without limitation, any of the following: endpoint, computing device, mobile device, mobile electronic device, user device, mobile station, subscriber station, portable electronic device, mobile communications device, wireless modem, wireless terminal, or another electronic device. Examples of an endpoint may include a mobile device, IoT (Internet of Things) device, EoT (Enterprise of Things) device, cellular phone, personal data assistant (PDA), smart phone, laptop, tablet, personal computer (PC), pager, portable computer, portable gaming device, wearable electronic device, health/medical/fitness device, camera, vehicle, or other mobile communications devices having components for communicating voice or data via a wireless communication network. A vehicle can include a motor vehicle (e.g., automobile, car, truck, bus, motorcycle, etc.), aircraft (e.g., airplane, unmanned aerial vehicle, unmanned aircraft system, drone, helicopter, etc.), spacecraft (e.g., spaceplane, space shuttle, space capsule, space station, satellite, etc.), watercraft (e.g., ship, boat, hovercraft, submarine, etc.), railed vehicle (e.g., train, tram, etc.), and other types of vehicles including any combinations of any of the foregoing, whether currently existing or after arising. The wireless communication network may include a wireless link over at least one of a licensed spectrum and an unlicensed spectrum. The term “mobile device” can also refer to any hardware or software component that can terminate a communication session for a user. In addition, the terms “user equipment,” “UE,” “user equipment device,” “user agent,” “UA,” “user device,” and “mobile device” can be used interchangeably herein.

The example system 100 includes the network 110. The network 110 represents an application, set of applications, software, software modules, hardware, or combination thereof, that can be configured to transmit data messages between the entities in the example system 100. The network 110 can include a wireless network, a wireline network, the Internet, or a combination thereof. For example, the network 110 can include one or a plurality of radio access networks (RANs), core networks (CNs), and the Internet. The RANs may comprise one or more radio access technologies. In some implementations, the radio access technologies may be Global System for Mobile communication (GSM), Interim Standard 95 (IS-95), Universal Mobile Telecommunications System (UMTS), CDMA2000 (Code Division Multiple Access), Evolved Universal Mobile Telecommunications System (E-UMTS), Long Term Evaluation (LTE), LTE-Advanced, the fifth generation (5G), or any other radio access technologies. In some instances, the core networks may be evolved packet cores (EPCs).

While elements of FIG. 1 are shown as including various component parts, portions, or modules that implement the various features and functionality, nevertheless, these elements may instead include a number of sub-modules, third-party services, components, libraries, and such, as appropriate. Furthermore, the features and functionality of various components can be combined into fewer components, as appropriate.

FIG. 2 is a flowchart showing an example operation 200 for determining if a binary file is malicious, according to an implementation. The example operation 200 can be implemented by a software service platform, e.g., the software service platform 106 shown in FIG. 1. The example operation 200 shown in FIG. 2 can be implemented using additional, fewer, or different operations, which can be performed in the order shown or in a different order.

As illustrated in FIG. 2, a binary file 202 is processed by a file encoder 210 to generate a file embedding vector 212. As previously mentioned, a binary file can cover a lot of different structured files depending on the architecture it is going to be executed.

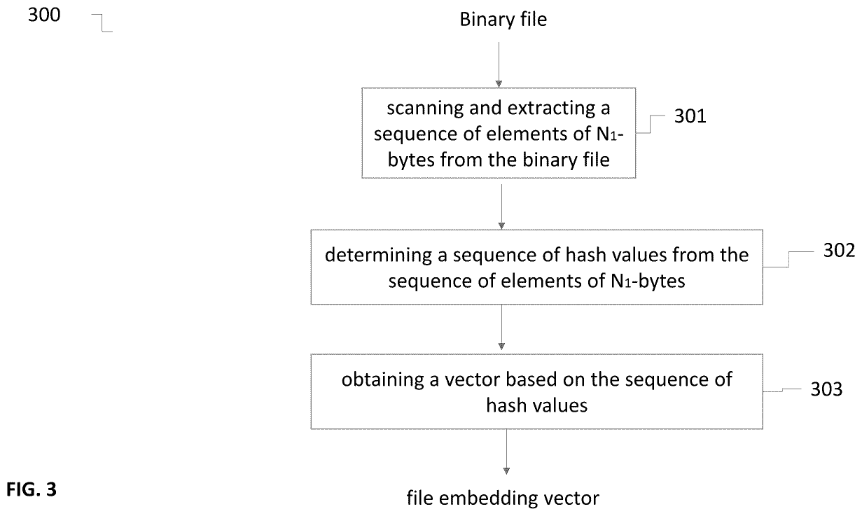

The file encoder 210 is a computer implemented method that generate a file embedding vector 212 based on the operations described in FIG. 3.

Once a file embedding vector has been generated, it is provided as an input to a trained machine learning model 214 in order to get an information relative to the maliciousness nature of the binary file. The information can take various forms depending on the implementation choices in the output layer of the trained machine learning model 214. For example, the information can be a score which is a numerical value, or it can be a categorial information (such as a label indicating either a malicious file or a non-malicious file). The details of the training of the machine learning to get the trained machine learning model 214 is described in connection with FIG. 4. There are many types of neural network architectures that can be used as a basis to establish the trained machine learning model 214. For example, the trained machine learning model 214 can have an architecture relying on the use of multilayer perceptron (MLP) or a convolutional neural network (CNN) or an attention layer (as used in a transformer model). Alternatively or additionally, trained machine learning model 214 may be a graph neural network, a recurrent neural network, other machine learning models, or any combinations thereof.

In a variant, instead of using a trained neural network model as a trained machine learning model 214, a trained tree-based classifier (which can also be viewed as a trained machine learning model), such as a decision tree, a random forest, or a gradient-boosted tree, can be used to classify a file embedding vector. Indeed, a given file embedding vector can be passed through the trained tree-based classifier: starting at a root node of the trained tree-based classifier, a splitting condition for a feature of the file embedding vector is checked; based on the result of the checking, the file embedding vector traverses down one of the branches of the trained tree-based classifier; then this process is repeated with other splitting conditions until reaching a leaf node in the tree-based classifier, which gives a predicted class associated with the given file embedding vector.

In a variant, several trained machine learning models can be used instead of just one trained machine learning model 214.

In another variant, one or several machine learning models can be used with one of several trained tree-based classifiers instead of just using one trained machine learning model 214.

In these variants, a combination of the scores can be performed (such as the determination of an average score), or a majority count can be determined (when using labels).

The description of FIG. 2 mentions only the processing of a binary file, however, the file encoder 210 and the trained machine learning model 214 can be adapted to handle source code files as explained later.

FIG. 3 is a flowchart presenting an example method 300 for generating a file embedding vector from a binary file relying on the use of one or several hash functions.

More precisely, given a binary file and according to a scanning process described in the following, several elements made up of N₁-bytes from the binary file are selected, with N₁ being an integer greater or equal to one. There are several ways to carry out this scanning and selecting process 301.

According to one implementation, the scanning and selecting process 301 depends of the structure of the binary file. Indeed as different binary file types have different formats and structures, the scanning and selecting process 301 can comprise an additional process for detecting the nature of the file in order to classify it as a PE file or an ELF file or another type of files. Then, it enables the order in which the scanning occurs. For example, if the binary file is an ELF file, according to one embodiment of the invention, elements made up of N₁-bytes are obtained by scanning the ELF Header from the beginning of the ELF header to the end of the ELF header. If the ELF header size is not a multiple of N₁, at the end of the scanning of the ELF header, zero bytes can be added to get an element of N₁-bytes. In parallel with or following this processing, the scanning of the ELF data and the selection of elements of N₁-bytes from the ELF data is done. In one embodiment, the scanning starts from the beginning of the ELF data until the end of the ELF data. In a variant, the scanning and selection is done based on the different types of sections. For example, in one embodiment, the process starts from the section header table, and then process bytes from the .data section, the .bss section, the .rodata section, the .symtab section, the strtab section, the .rel.data section, the .text section and the .rel.text section in this order. In a variant, other orders of processing of the sections may be considered. In addition, in a variant, some bytes that have no interest can be discarded from the scanning and selecting step. Indeed, it is unlikely that important information about the dangerousness of the file is included in sections such as the .comment section or .note section from the ELF data. These sections respectively contain optional comments, metadata and notes/annotations.

A similar process can be performed on other types of binary files (i.e. having a specific scanning order of bytes depending on the structure of the binary file induced by its type). For example, the components of an apk file can be scanned according to a specific order.

According to one implementation, the scanning and selecting process 301 is done without considering the structure of the binary file. In this variant, it enables a binary file to be processed quickly. Therefore, in this embodiment of the invention, the binary file is processed as a whole. For example, starting from the beginning of the binary file, a number N₁ of bytes are selected at the beginning of the process, and then, according to a sliding window of value equal to N₁, other bytes are selected each time by group of N₁ of bytes. This process is repeated until all the bytes in the binary file have been scanned. Once again, if the binary file size is not a multiple of N₁, either zero bytes are added to have a final group of N₁ bytes, or the number of bytes in the final group of bytes is less than N₁ bytes and will be used as it is in subsequent processing. In a variant, the starting point of the scanning process is not the beginning of the binary file but the end of the binary file. This means that the bytes in the binary file are scanned and selected in the opposite direction of the one of the previous embodiment. In other variants, the starting point of the scanning and selection process is defined as a given position in the binary file. In this case, the bytes can be scanned towards the end of the binary file. Once the end of the file is reached, the other unscanned bytes are scanned starting from the beginning of the binary file (this scanning and selecting process can be seen as a cyclic process). In another variant, if the starting point of the scanning and selection process is defined as a given position in the binary file, the bytes can be scanned in the opposite direction compared to the previous embodiment (i.e. towards the beginning of the binary file). Here again, once the beginning of the binary file is reached, the scanning and selection process continues by starting from the end of the binary file. These examples are not exhaustive and one skilled in the art could use other ways of scanning and selecting bytes in the binary file in the spirit of the described examples.

In one embodiment of the disclosure, each time that N₁ bytes are selected, these are supplied as input to a hash function. The output of the hash function is positioned in a vector of data which is a file embedding vector. Hence, according to this embodiment, obtaining such file embedding vector is done on the fly. In one variant, intermediate memory buffers may be used to prepare the data to be hashed by a hash function. Both approaches enable the determination 302 of a sequence of hash values.

Different types of hash functions can be used; for example, a non-cryptographic hash function such as the Pearson hash function or the MurmurHash function can process inputs of N₁ bytes, as selected previously. The size of the output of the Pearson hash function is typically 8 bits (1 byte). Therefore, the output of the Pearson hash function is just a number between 0 and 255. However, it is possible to generate larger hash values (16-bit, 32-bit, 64-bit, etc.) by running the Pearson algorithm multiple times with different initial conditions.

In addition, the most common versions of MurmurHash are MurmurHash2 and MurmurHash3. They can generate outputs of 32-bit, 64-bit, and even 128-bit sizes.

In another variant, two hash functions can be used to process a same input of N₁ bytes. According to this embodiment, a truncation of the concatenation of the two hash values can also be performed in order to limit the size of the hash values. The truncation is defined as the output result, and is used to define/generate the sequence of hashes. For example, given an input of N₁ bytes, a Pearson hash function outputting a single byte as result can be used. Then, a Pearson hash function, with a different permutation table, outputting also a single byte as result can be used on the same input of N₁ bytes. Therefore, for a given input of N₁ bytes, two bytes (i.e. 16 bits) are obtained from the use of two hash functions. However, instead of using the two bytes in a sequence of hashes, a truncation can be performed. Indeed, in one embodiment, the lower 12 bits from the 16 bits are kept. These 12 bits define a hash value. In a variant, another selection function can be used to extract a number of bits amongst the 16 bits. For example, the selection function can take the highest 12 bits from the 16 bits. In a variant, the two most significant bits and the two least significant bits are discarded by the selection function in order to get the 12 remaining bits. The selected bits correspond to the hash value associated with the given input of N₁ bytes.

In one embodiment, the number N₁ is an integer that belongs to a range from 2 to 15.

In a variant, before executing the scanning and selecting step, a preprocessing step can be performed. Such preprocessing may remove zero bytes comprised in the binary file. Indeed, a zero byte can be a special character that appears after every byte (either due to syntax/structure requirements (for aligning sections or instructions for example) or for integrity purposes). Hence, these zero bytes can be considered in some way as noise, and may prevent the extraction of truly relevant information. In a variant, the preprocessing step may remove other byte values such as a value of 0x90, in hexadecimal format, which corresponds to a NOP (“no operations”) instruction in x86, or other values related to debugging purposes.

According to one implementation, several file embedding vectors can be generated for a given binary file. Indeed, in this embodiment, once a first file embedding vector has been generated, another one can be generated by reiterating the processing with a value N₂ different of N₁. It should be noted that the generation of these vectors can be done in parallel.

Therefore, in a variant, given a binary file, it is possible to generate from 2 to 10 file embedding vectors or vectors by using several different values for N₁ and by repeating the described process.

According to one implementation, all these vectors can be concatenated, and provided to a trained machine learning model 214.

In a variant, each vector is used as an input for different trained machine learning models. Then, based on the output of each trained model, a majority vote can be done in order to classify the given file as a malicious file or a non-malicious file. In the case that each trained model outputs a score value (i.e. a real value between 0 and 1 for example), a mean of these scores can be determined in order to get an updated score. In the case that the updated score is close to a boundary (i.e. close to 0 or close to 1, it gives a strong indication on the dangerousness of the file or not; however, if the updated score is close to 0.5, it is difficult to classify the given file into one of these categories).

In a variant, instead of providing as an input a vector comprising hash values, the vector to be provided to a trained machine learning model is obtained as follows: once all the hash values have been obtained or determined, a histogram vector is determined. The histogram vector is a numerical representation of a histogram of the hashes, which is a graphical representation of the distribution of the hashes. Hence, this vector comprises, for each possible hash values defined by a position in the vector, a number that corresponds to the frequency or count of hashes having this value. This vector is obtained in a step 303.

In a variant, several histogram vectors can be obtained for a given binary file (by repeating the scanning and selection process with different values of N₁ for a given binary file).

Therefore, the file embedding vector mentioned in FIG. 3 can be either a histogram vector as explained previously, or a vector being a concatenation of vectors of hash values as also explained previously. In a variant, it can also be a concatenation of histogram vectors to be provided to a trained machine learning model 214.

According to one embodiment of the disclosure, a normalization process can be executed on the vectors before being used as input data by a trained machine learning model. For example, a Min-Max Normalization (Rescaling) can be done.

In the previous examples, the scanning and extraction 301 focuses on the bytes from the binary file. However, in a variant, instead of using bytes, the scanning and extraction step can be done on nibbles (i.e. groups of 4 bits). In another variant, the method 300 can be adapted to generate a file embedding vector for a source code file instead of a binary file. Indeed, in one implementation, a compiler can be used to generate a binary file from a source code file, and then the method 300 can be executed to get, for a source code file, a corresponding file embedding vector. In another implementation, a source code file is converted into a binary file by encoding text/instructions from the source code files into numerical values by using character's ASCII or UTF-8-byte representation. Then, the method 300 can be executed on this kind of binary file (i.e. a file comprising 0s and 1s, but that can not be executed as it is). In another implementation, a tokenization process is used to split a source code file into tokens such as keywords, operators, identifiers of variables, functions, special characters, literals (numbers, strings)). Then a device performs a one-hot encoding of the tokens. The concatenation of the encoded tokens can be viewed as a binary file that is then provided as input of the method 300. In another implementation, the method 300 is adapted to tokenize a source code file, with tokens being represented as integers of the same size (in bits, such as 32-bits or 64-bits). Then, instead of grouping N₁ bytes as previously, the method 300 handles the grouping of N₁ tokens. The same operations are performed but on elements of N₁ tokens instead of N₁ bytes.

Whatever the approach chosen, it is important to be consistent in the implementation.

In a variant, a trained autoencoder can be used in order to add data to the vector obtained from the method described in FIG. 3. Indeed, in one embodiment of the disclosure, the encoder model of a trained autoencoder is used to get a representation of a given binary file in a latent space. This latent space representation of the given binary file, which is a vector, is then combined (via a concatenation for example) with the vector obtained from the method described in FIG. 3. The vector resulting from this combination is then used as input for another trained malware classification model.

According to one implementation, FIG. 4 is a flowchart presenting an example method 400 for training a machine learning model to be used in the context described in FIGS. 1-3.

It is commonly known that machine learning models are trained using a process that involves feeding them large amounts of data and allowing them to learn patterns and relationships within that data.

Therefore, it is important to obtain 401 a dataset of binary files having numerous different files. In one embodiment of the disclosure, several datasets can be obtained, and each dataset of binary files gather files of the same type (i.e. for example a first dataset with only ELF files, a second dataset with only EXE file, etc.). In a variant, a dataset of source code files can be available to train a specific machine learning model.

Then, each dataset of binary files (or source code files) is used to train a machine learning model either according to a supervised learning approach or an unsupervised learning approach. In the supervised learning approach, each dataset of files comprises for each file a label indicating the maliciousness of the file.

The training process comprises a preprocessing step similar to the process described in FIG. 3. Indeed, each binary file or source code file from a given dataset must be converted in a file embedding vector/vector. Hence, a preprocessing step that generates a dataset of vectors from a dataset of binary files or source code files must be performed. The preprocessing step keeps the label or information that indicates the maliciousness of the binary file or source code file if such label or information is comprised in the dataset of binary files or source code files.

Once the preprocessing step is done, a data splitting process can be executed in order to divide a given dataset of vectors/file embedding vectors into a training set and a testing set. The training set is used to train the model, while the testing set is used to evaluate its performance.

According to one embodiment of the disclosure, different neural network models can be chosen to be trained. For example, a feedforward neural network (FNN), also called a multi-layer perceptron (MLP), can be used. In a variant, a Convolutional Neural Network (CNN) can be chosen to be trained. In another variant, a Recurrent Neural Networks (RNN) or a Long Short-Term Memory (LSTM) Network can be chosen. Moreover, other architectures relying on the use of transformers or hybrid approaches relying on the use of an MLP combined with autoencoders can be chosen. Of course, the way in which the vectors/file embedding vectors are formatted must be modified according to the nature of the models to be used. One skilled in the art would adapt the input format based on vectors obtained from the process described in FIG. 3. In addition, the way in which the parameters and hyperparameters of each model are chosen is not described in the present document. But one skilled in the art would understand that based on the results of the training of these models, modification of these parameters and hyperparameters is done to obtain better results. Indeed, in order to determine these parameters and hyperparameters, comparison of results has to be done. Factors such as the number of layers, the number of neurons per layer, the activation functions, and the optimization algorithm has an important impact on the behavior of a model. This is the purpose of fine tuning which is beyond the scope of the present document.

Once a neural network architecture is chosen, the model training 402 is performed by using the training dataset, the use of a loss function that measures the discrepancy between the model's predictions and the true values, and the use of an optimization algorithm (e.g., gradient descent) to update the parameters (weights) iteratively to minimize the loss function. Indeed, during the model training, the internal parameters (weights and biases) are modified in order to minimize the difference between the predictions of the model and the actual values in the training data.

The model training 402 further comprises an evaluation step that evaluate the trained model on the testing dataset to assess its performance. Based on the results, either model refinement can be done (i.e. such as the adjustment of the hyperparameters of the model) or the training process can stop at this stage if the performance metrics fulfill a stopping criteria.

In one embodiment, once a trained machine learning model is obtained/generated, it can be deployed to the software service platform 106.

The training process and deployment of a trained machine learning model can be reiterated regularly based on parameters of a security policy, the parameters defining for example a time range or frequency at which to carry out the training. In other case, a security alarm can be the event that trigger the launch of a new training of the one or several models.

Similarly to the process described in connection with FIG. 4, it is possible to train a tree-based classifier (at least in the preparation of data (via the process from FIG. 3), and the split of the vectors into a training dataset and a testing dataset.

One or several trained tree-based classifiers can be obtained/generated, and then deployed to the software service platform 106.

In a variant, the software service platform 106 can run both tree-based classifiers and trained neural networks models to assess a given file.

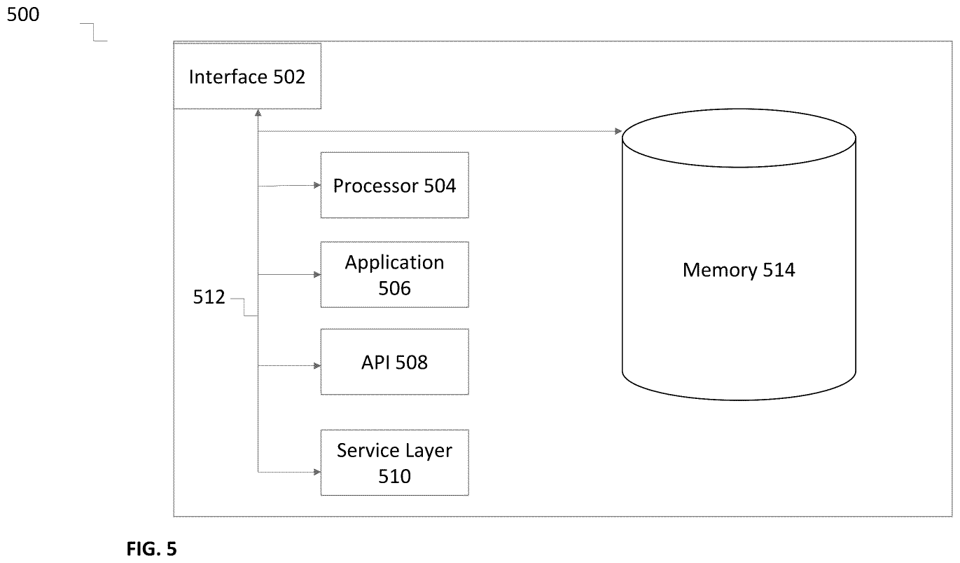

FIG. 5 illustrates a high-level architecture block diagram of a computer 500 according to an implementation. The computer 500 can be implemented as the client device 102, the software service platform, or any combinations thereof. The computer 500 can also be used to implement the operations discussed in FIGS. 1-4. The described illustration is only one possible implementation of the described subject matter and is not intended to limit the disclosure to the single described implementation. Those of ordinary skill in the art will appreciate the fact that the described components can be connected, combined, and/or used in alternative ways consistent with this disclosure.

In some cases, the steps of FIG. 3 can be implemented in an executable computing code, e.g., C/C++ executable codes. In some cases, the computer 500 can include a standalone Linux system that runs batch applications. In some cases, the computer 500 can include mobile or personal computers.

The computer 500 may comprise a computer that includes an input device, such as a keypad, keyboard, touch screen, microphone, speech recognition device, other device that can accept user information, and/or an output device that conveys information associated with the operation of the computer, including digital data, visual and/or audio information, or a GUI.

The computer 500 can serve as a client, network component, a server, a database, or other persistency, and/or any other components. In some implementations, one or more components of the computer 500 may be configured to operate within a cloud-computing-based environment.

At a high level, the computer 500 is an electronic computing device operable to receive, transmit, process, store, or manage data. According to some implementations, the computer 500 can also include or be communicably coupled with an application server, e-mail server, web server, caching server, streaming data server, business intelligence (BI) server, and/or other server.

The computer 500 can collect data of network events or mobile application usage events over network 110 from a web browser or a client application, e.g., an installed plugin. In addition, data can be collected by the computer 500 from internal users (e.g., from a command console or by another appropriate access method), external or third parties, other automated applications, as well as any other appropriate entities, individuals, systems, or computers.

Each of the components of the computer 500 can communicate using a system bus 512. In some implementations, any and/or all the components of the computer 500, both hardware and/or software, may interface with each other and/or the interface 502 over the system bus 512 using an Application Programming Interface (API) 508 and/or a service layer 510. The API 508 may include specifications for routines, data structures, and object classes. The API 508 may be either computer language-independent or -dependent and refer to a complete interface, a single function, or even a set of APIs. The service layer 510 provides software services to the computer 500. The functionality of the computer 500 may be accessible for all service consumers using this service layer. Software services, such as those provided by the service layer 510, provide reusable, defined business functionalities through a defined interface. For example, the interface may be software written in JAVA, C++, or other suitable languages providing data in Extensible Markup Language (XML) format or other suitable format. While illustrated as an integrated component of the computer 500, alternative implementations may illustrate the API 508 and/or the service layer 510 as stand-alone components in relation to other components of the computer 500. Moreover, any or all parts of the API 508 and/or the service layer 510 may be implemented as child or sub-modules of another software module, enterprise application, or hardware module without departing from the scope of this disclosure.

The computer 500 includes an interface 502. Although illustrated as a single interface 502 in FIG. 5, two or more interfaces 502 may be used according to particular needs, desires, or particular implementations of the computer 500. The interface 502 is used by the computer 500 for communicating with other systems in a distributed environment connected to a network (whether illustrated or not). Generally, the interface 502 comprises logic encoded in software and/or hardware in a suitable combination and operable to communicate with the network. More specifically, the interface 502 may comprise software supporting one or more communication protocols associated with communications such that the network or interface's hardware is operable to communicate physical signals within and outside of the computer 500.

The computer 500 includes at least one processor 504. Although illustrated as a single processor 504 in FIG. 5, two or more processors may be used according to particular needs, desires, or particular implementations of the computer. Generally, the processor 504 executes instructions and manipulates data to perform the operations of the computer 500. Specifically, the processor 504 executes the functionality disclosed in FIGS. 1-4.

The computer 500 also includes a memory 514 that holds data for the computer 500. Although illustrated as a single memory 514 in FIG. 5, two or more memories may be used according to particular needs, desires, or particular implementations of the computer 500. While memory 514 is illustrated as an integral component of the computer 500, in alternative implementations, memory 514 can be external to the computer 500.

The application 506 is an algorithmic software engine providing functionality according to particular needs, desires, or particular implementations of the computer 500, particularly with respect to functionality required for anomaly detection. Although illustrated as a single application 506, the application 506 may be implemented as multiple applications 506 on the computer 500. In addition, although illustrated as integral to the computer 500, in alternative implementations, the application 506 can be external to the computer 500.

There may be any number of computers 500 associated with, or external to, and communicating over a network. Furthermore, this disclosure contemplates that many users may use one computer 500, or that one user may use multiple computers 500.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a standalone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer readable media for storing computer program instructions and data can include all forms of permanent/non-permanent or volatile/non volatile memory, media and memory devices, including by way of example semiconductor memory devices, for example, random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto optical disks; and optical memory devices, for example, digital versatile/video disc (DVD), compact disc (CD) ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back end, middleware, or front end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an API and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in XML format or other suitable formats. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Described implementations of the subject matter can include one or more features, alone or in combination.

For example, in an implementation, it is proposed a first feature that deals with a method for detecting a malware file, the method comprising:
obtaining a file to be classified as either a malware file or a non-malware file;
obtaining a sequence of elements of N₁-bytes or N₁-tokens from the file, with N₁ being an integer greater or equal to one;
determining a sequence of hash values from the sequence of elements of N₁-bytes or N₁-tokens;
obtaining a vector based on the sequence of hash values;
providing a trained model with the obtained vector as input, the trained model outputting a data whose value enables a classification of the file as either a malware file or a non-malware file.

A second feature, combinable with any of the previous or following features, relates to a method for detecting a malware file, wherein the vector comprises a sequence of counters of the number of occurrences of the hash values within the sequence of hash values.

A third feature, combinable with any of the previous or following features, relates to a method for detecting a malware file, wherein the sequence of elements of N₁-bytes or N₁-tokens is a partition of the file that is either exactly overlapping the content of the file or that is shorter than the size of the file.

A fourth feature, combinable with any of the previous or following features, relates to a method for detecting a malware file, wherein obtaining the sequence of elements of N₁-bytes or N₁-tokens comprises collecting from the beginning of the file and according to a sliding window of length N₁, moving towards end of the file, the elements of N₁-bytes or N₁-tokens.

A fifth feature, combinable with any of the previous or following features, relates to a method for detecting a malware file, wherein obtaining the sequence of elements of N₁-bytes or N₁-tokens comprises collecting from the end of the binary file and according to a sliding window of length N₁, moving towards beginning of the file, the elements of N₁-bytes or N₁-tokens.

A sixth feature, combinable with any of the previous or following features, relates to a method for detecting a malware file, wherein obtaining the sequence of elements of N₁-bytes or N₁-tokens comprises collecting from a given position of the file and according to a sliding window of length N₁, moving towards either the beginning of the file or the end of the file, the elements of N₁-bytes or N₁-tokens, with a cyclic loop when either the beginning of the file or the end of the file is reached.

A seventh feature, combinable with any of the previous or following features, relates to a method for detecting a malware file, wherein the hash values are obtained from the processing of a non-cryptographic hash function.

An eighth feature, combinable with any of the previous or following features, relates to a method for detecting a malware file, wherein the hash values are obtained from the processing of elements of N₁-bytes or N₁-tokens by two non-cryptographic hash functions.

A ninth feature, combinable with any of the previous or following features, relates to a method for detecting a malware file, wherein the non-cryptographic hash function is one of a Pearson hash function or MurmurHash.

A tenth feature, combinable with any of the previous or following features, relates to a method for detecting a malware file, wherein determining the sequence of hash values from the sequence of elements of N₁-bytes or N₁-tokens comprises applying a hash function on each element of the sequence of elements of N₁-bytes or N₁-tokens.

An eleventh feature, combinable with any of the previous or following features, relates to a method for detecting a malware file, wherein determining the sequence of hash values from the sequence of elements of N₁-bytes or N₁-tokens comprises applying a hash function on at least some elements of the sequence of elements of N₁-bytes or N₁-tokens, wherein the at least some elements are selected according to a selection function.

A twelfth feature, combinable with any of the previous or following features, relates to a method for detecting a malware file, wherein, when the file is a binary file, it further comprises removing zero bytes in the binary file before performing obtaining the sequence of elements of N₁-bytes.

A thirteenth feature, combinable with any of the previous or following features, relates to a method for detecting a malware file, wherein it further comprises normalizing the vector before providing it to the trained model.

A fourteenth feature, combinable with any of the previous or following features, relates to a method for detecting a malware file, wherein it further comprises obtaining a second sequence of elements of N₂-bytes or N₂-tokens from the file, with N₂ being an integer greater or equal to one and different from N₁, and wherein it further comprises:
determining for at least some elements of the second sequence a hash value, the determining delivering a second sequence of hash values;
obtaining a second vector based on the second sequence of hash values; and providing a second trained model with the obtained second vector as input, the second trained model outputting a second data whose value enables a classification of the file as either a malware file or a non-malware file.

A fifteenth feature, combinable with any of the previous or following features, relates to a method for detecting a malware file, wherein the trained model and the second trained model have different architectures.

A sixteenth feature, combinable with any of the previous or following features, relates to a method for detecting a malware file, wherein the classification of the file as either a malware file or a non-malware file is done based on a majority vote or a combination of the data and the second data.

A seventeenth feature, combinable with any of the previous or following features, relates to a method for detecting a malware file, wherein obtaining the sequence of elements of N₁-bytes or N₁-tokens is done only for a part of the file selected amongst a section header table and/or a code section.

The previously described example implementations do not define or constrain the present disclosure. Other changes, substitutions, and alterations are also possible without departing from the scope of the present disclosure.

In a variant, features previously mentioned can be implemented either in hardware or as a computer program.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

At last, according to an embodiment, some machine learning models can be run on Central Processing Unit (CPU) that are general-purpose processors that handle most types of computing tasks. In a variant, Graphics Processing Unit (GPU) which are specialized hardware designed for parallel computing can be used to run or train machine learning models mentioned in this document. Moreover, in a variant, Tensor Processing Unit (TPU) can be used. Therefore a device that comprises at least one of these different processors can execute part of the processes that involve the use of machine learning models.

1. A computer-implemented method for detecting a malware file, the method comprising:
obtaining a file to be classified as either a malware file or a non-malware file;
obtaining a sequence of elements of N₁-bytes or N₁-tokens from the file, with N₁ being an integer greater or equal to one;
determining a sequence of hash values from the sequence of elements of N₁-bytes or N₁-tokens;
obtaining a vector based on the sequence of hash values;
providing a trained model with the obtained vector as input, the trained model outputting a data whose value enables a classification of the file as either a malware file or a non-malware file.

2. The computer-implemented method of claim 1, wherein the vector comprises a sequence of counters of the number of occurrences of the hash values within the sequence of hash values.

3. The computer-implemented method of claim 1, wherein the sequence of elements of N₁-bytes or N₁-tokens is a partition of the file that is either exactly overlapping the content of the file or that is shorter than the size of the file.

4. The computer-implemented method of claim 1, wherein obtaining the sequence of elements of N₁-bytes or N₁-tokens comprises collecting from the beginning of the file and according to a sliding window of length N₁, moving towards end of the file, the elements of N₁-bytes or N₁-tokens.

5. The computer-implemented method of claim 1, wherein obtaining the sequence of elements of N₁-bytes or N₁-tokens comprises collecting from the end of the binary file and according to a sliding window of length N₁, moving towards beginning of the file, the elements of N₁-bytes or N₁-tokens.

6. The computer-implemented method of claim 1, wherein obtaining the sequence of elements of N₁-bytes or N₁-tokens comprises collecting from a given position of the file and according to a sliding window of length N₁, moving towards either the beginning of the file or the end of the file, the elements of N₁-bytes or N₁-tokens, with a cyclic loop when either the beginning of the file or the end of the file is reached.

7. The computer-implemented method of claim 1, wherein the hash values are obtained from the processing of a non-cryptographic hash function.

8. The computer-implemented method of claim 1, wherein the hash values are obtained from the processing of elements of N₁-bytes or N₁-tokens by two non-cryptographic hash functions.

9. The computer-implemented method of any claim 7 or 8, wherein the non-cryptographic hash function is one of a Pearson hash function or MurmurHash.

10. The computer-implemented method of claim 1, wherein determining the sequence of hash values from the sequence of elements of N₁-bytes or N₁-tokens comprises applying a hash function on each element of the sequence of elements of N₁-bytes or N₁-tokens.

11. The computer-implemented method of claim 1, wherein determining the sequence of hash values from the sequence of elements of N₁-bytes or N₁-tokens comprises applying a hash function on at least some elements of the sequence of elements of N₁-bytes or N₁-tokens, wherein the at least some elements are selected according to a selection function.

12. The computer-implemented method of claim 1, wherein, when the file is a binary file, it further comprises removing zero bytes in the binary file before performing obtaining the sequence of elements of N₁-bytes.

13. The computer-implemented method of claim 1, wherein it further comprises normalizing the vector before providing it to the trained model.

14. The computer-implemented method of claim 1, wherein it further comprises obtaining a second sequence of elements of N₂-bytes or N₂-tokens from the file, with N₂ being an integer greater or equal to one and different from N₁, and wherein it further comprises:
determining for at least some elements of the second sequence a hash value, the determining delivering a second sequence of hash values;
obtaining a second vector based on the second sequence of hash values; and
providing a second trained model with the obtained second vector as input, the second trained model outputting a second data whose value enables a classification of the file as either a malware file or a non-malware file.

15. The computer-implemented method of claim 14, wherein the trained model and the second trained model have different architectures.

16. The computer-implemented method of claim 14, wherein the classification of the file as either a malware file or a non-malware file is done based on a majority vote or a combination of the data and the second data.

17. The computer-implemented method of claim 1, wherein obtaining the sequence of elements of N₁-bytes or N₁-tokens is done only for a part of the file selected amongst a section header table and/or a code section.

18. A computer-readable medium containing instructions which, when executed, cause an electronic device to perform operations for detecting a malware file, the operations comprising:
obtaining a file to be classified as either a malware file or a non-malware file;
obtaining a sequence of elements of N₁-bytes or N₁-tokens from the file, with N₁ being an integer greater or equal to one;
determining a sequence of hash values from the sequence of elements of N₁-bytes or N₁-tokens;
obtaining a vector based on the sequence of hash values;
providing a trained model with the obtained vector as input, the trained model outputting a data whose value enables a classification of the file as either a malware file or a non-malware file.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for detecting a malware file, the one or more operations comprising:
obtaining a file to be classified as either a malware file or a non-malware file;
obtaining a sequence of elements of N₁-bytes or N₁-tokens from the file, with N₁ being an integer greater or equal to one;
determining a sequence of hash values from the sequence of elements of N₁-bytes or N₁-tokens;
obtaining a vector based on the sequence of hash values;
providing a trained model with the obtained vector as input, the trained model outputting a data whose value enables a classification of the file as either a malware file or a non-malware file.
